(19) United States
(12) Patent Application Publication
(10) Pub. No.: US 2026/0292881 A1
(43) Pub. Date: Sep. 24, 2026

(54) METHODS, DEVICES AND MEDIUM FOR CONFLICT MANAGEMENT

(71) Applicant: Telefonaktiebolaget LM Ericsson (publ), Stockholm (SE)

(72) Inventors: Huichen WANG, Beijing (CN); Yu ZHANG, Guangzhou (CN); Jie CHEN, Beijing (CN); Jiajun JIAN, Guangzhou (CN)

(73) Assignee: Telefonaktiebolaget LM Ericsson (publ), Stockholm (SE)

(21) Appl. No.: 19/475,447

(22) PCT Filed: Apr. 17, 2023
(86) PCT No.: PCT/CN2023/088775

§ 371 Date: Oct. 15, 2025

(51) Int. Cl. H04W 74/0816; H04W 72/23

(52) U.S. Cl. CPC H04W 74/0816; H04W 72/23

(57) ABSTRACT

Embodiments of the present disclosure relate to methods, devices, and computer readable storage medium for conflict management. In a method, a network node performs a first communication with a terminal device using a plurality of NBs to mitigate collision between the first communication and a different second communication with a terminal device.

### FIELDS

Various embodiments of the present disclosure generally relate to the field of telecommunication and in particular, to methods, devices, and computer readable storage medium for conflict management.

### BACKGROUND

This section introduces aspects that may facilitate a better understanding of the disclosure. Accordingly, the statements of this section are to be read in this light and are not to be understood as admissions about what is in the prior art or what is not in the prior art.

Category M (Cat-M) is a low power wide area (LPWA) technology which can support massive internet of thing (IoT). A Cat-M device may operate on a narrower frequency band (for example, 1.4 MHz). This allows more terminal devices to be served in a coverage area of a network node on an available spectrum. Moreover, due to lower power consumption, a Cat-M device may operate in a low power mode and achieve an extended battery life. Nowadays, a growth of Cat-M traffic is observed in deployments of Mobile Network Operators (MNO).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

As mentioned above, more and more Cat-M traffic occurs due to narrower band requirements and lower power consumption. A Cat-M system may share spectrum resources with long term evolution (LTE) and New Radio (NR) systems, and Cat-M traffic can be transported in a unit of a narrowband (NB) including 6 physical resource blocks (PRBs). As one NB may be not enough to meet user requirements, multiple NBs are enabled for Cat-M traffic. However, the extension from one NB to multiple NBs may cause resource collision between the Cat-M system and the LTE and NR systems.

To overcome or mitigate at least one of the above-mentioned problems or other problems or provide a useful solution, embodiments of the present disclosure propose communication methods, communication devices and storage medium.

In a first aspect of the present disclosure, there is provided a method of a network node. In the method, the network node performs a first communication with a terminal device using a plurality of NBs to mitigate collision between the first communication and a different second communication with a terminal device.

In an embodiment, the network node may allocate, in the plurality of NBs, a resource for the first communication to mitigate the collision between the first and second communications.

In an embodiment, the first communication may be performed with a first radio interface technology (RIT) and the second communication is performed with a different second RIT.

In an embodiment, the network node may allocate, in the plurality of NBs, at least one NB for the first communication with the first RIT. The allocated at least one NB may be separate from at least one NB of the plurality of NBs for a coreset associated with the second RIT, and the second communication is performed on the at least one NB of the plurality of NBs for the coreset.

In an embodiment, the first communication may comprise: a transmission of system information, SI, a transmission of a system information block, SIB, or a transmission in a common search space (CSS) available for a machine type communication (MTC) physical downlink control channel (MPDCCH).

In an embodiment, a NB of the plurality of NBs may comprise a plurality of resource blocks, and an order for searching resource blocks in the at least one NB allocated for the first communication with the first RIT is reversed from an order for allocating resource blocks of the at least one NBs of the plurality of NBs for the coreset associated with the second RIT.

In an embodiment, the first communication comprises a transmission of system information (SI) and an index of the NB is allocated for the transmission of SI to reduce loss of resources for the second communication.

In an embodiment, the first communication may comprise a transmission in a CSS available for a MPDCCH. The network node may allocate, in the plurality of NBs, continuous NBs for the transmission in the CSS.

In an embodiment, the continuous NBs may be allocated for the transmission in a type-2 common search space (CSS2). The second communication may comprises: a transmission of system information block type 1 (SIB1); a transmission of system information (SI); a transmission in a type-1 common search space (CSS1) for the MPDCCH; a transmission of a synchronization signal; and/or a transmission on a physical broadcast channel (PBCH).

In an embodiment, the first communication may comprise a transmission in a user equipment (UE) specific search space (USS) for a MPDCCH or a transmission on a physical downlink shared channel (PDSCH) associated with the MPDCCH. The network node may allocate, in the plurality of NBs, at least one NB for the transmission in the USS for the MPDCCH or the transmission on the PDSCH.

In an embodiment, the allocated at least one NB may exclude: a NB for a transmission of a synchronization signal; and/or a NB for a transmission on a PBCH. The second communication may comprise the transmission of the synchronization signal and/or the transmission on the PBCH.

In an embodiment, the synchronization signal may comprise a primary synchronization signal (PSS) and/or a secondary synchronization signal (SSS).

In an embodiment, the first communication may be performed with a first RIT. The second communication may comprise a transmission in a coreset associated with a different second RIT. At least one NB of the plurality of NBs for the coreset may have the lowest priority for allocating the at least one NB for the first communication.

In an embodiment, the coreset may comprise coreset #0.

In an embodiment, the first RIT may comprise category M (Cat-M), and the second RIT may comprise long term evolution (LTE) or new radio (NR).

In an embodiment, the at least one NB allocated for the transmission in the USS for the MPDCCH or the transmission on the PDSCH may be reused for: a transmission of system information block type 1 (SIB1); a transmission of system information, SI; or a transmission in a type-1 common search space (CSS1) on the MPDCCH.

In an embodiment, the network node may determine that the transmission in the USS for the MPDCCH or the transmission on the PDSCH is to conflict with the transmission of SIB1 on at least one subframe in the at least one NB to be allocated. If the number of repetitions for the transmission in the USS for the MPDCCH or the transmission on the PDSCH is equal to or greater than a first threshold number, the network node may allocate the at least one NB for the transmission in the USS for the MPDCCH or the transmission on the PDSCH.

In an embodiment, the network node may in response to the number of repetitions for the transmission in the USS being less than the first threshold number, determine whether that the USS is valid. If the USS is valid, the network node 120 may increase the number of repetitions.

In an embodiment, the network node may in response to the number of repetitions for the transmission on the PDSCH being less than the first threshold number, increase the number of repetitions.

In an embodiment, the number of repetitions may be increased to a next higher available number.

In an embodiment, the network node may in response to the number of repetitions for the transmission in the USS for the MPDCCH or on the PDSCH being equal to or greater than the first threshold number, drop the conflicting at least one subframe to avoid collision between the transmission in the USS for the MPDCCH or on the PDSCH and the transmission of SIB1.

In an embodiment, the network node may in response to no collision of the transmission in the USS for the MPDCCH or the transmission on the PDSCH with the transmission in the CSS1 on the MPDCCH or the transmission of the SI in the at least one

NB to be allocated, allocate the at least one NB for the transmission in the USS for the MPDCCH or the transmission on the PDSCH.

In an embodiment, the transmission of the SI may be performed on at least one predetermined subframe and/or in a predetermined frame after cell setup.

In an embodiment, the at least one predetermined subframe may comprise continuous subframes.

In an embodiment, the first communication may be performed on a MPDCCH with repetitions.

In an embodiment, the network node may determine that a preamble is qualified before a starting of the MPDCCH with repetitions. In this embodiment, the preamble corresponds to the MPDCCH. The network node may block preamble selection of a terminal device in a time interval after the qualification of the preamble and before the starting of the MPDCCH.

In an embodiment, the preamble may be determined to be qualified on a target subframe earlier than a starting subframe of the MPDCCH. In this embodiment, three subframes may be between the target subframe and the starting subframe.

In an embodiment, the MPDCCH with repetitions may be associated with a first CSS and a different second CSS.

In an embodiment, the network node may determine that a first preamble in a first list of preambles associated with the first CSS and a second preamble in a second list of preambles associated with the second CSS are both qualified before a starting of the MPDCCH, wherein the first and second preambles correspond to the MPDCCH. The network node may block a preamble in one of the first and second lists of preambles in a time interval after the qualification of the first and second preambles and before the starting of the MPDCCH. In this embodiment, a CSS of the first and second CSSs associated with the other of the first and second lists may be scheduled in a previous scheduling occasion.

In an embodiment, the network node may determine that a first preamble in a first list of preambles associated with the first CSS is qualified before a starting of the MPDCCH, wherein the first preamble corresponds to the MPDCCH. The network node may block a preamble in the first list of preambles in a time interval after the qualification of the first preamble and before the starting of the MPDCCH.

In an embodiment, the blocking may be performed in response to no occasion of a physical random access channel (PRACH) in the time interval.

In an embodiment, the first and second communications are performed on a physical uplink control channel (PUCCH.)

In an embodiment, the first communication may comprise a transmission of hybrid automatic repeat request-acknowledgement (HARQ-ACK) on the PUCCH. The network node may determine, from resource indexes for the PUCCH, a first set of resource indexes available for the transmission of the HARQ-ACK. The network node may allocate, from the second set of resource indexes, a resource index for the transmission of the HARQ-ACK.

In an embodiment, the resource index for the transmission of the HARQ-ACK is allocated to cause concentrated distribution of resource indexes allocated for transmissions of HARQ-ACK on the PUCCH.

In an embodiment, the network node may allocate, from the first set of resource indexes, a resource index for the transmission of the HARQ-ACK as a function of:

$${n}_{PUCCH}^{( 1 , {p}_{0} )} = {n}_{ECCE , q} + {Δ}_{ARO} + {N}_{PUCCH , q}^{( m 1 )} ,$$

$${n}_{PUCCH}^{( 1 , {p}_{0} )}$$

may be the allocated resource index, N_{ECCE} may be the number of the lowest enhanced control channel element (ECCE) indexes used to construct a MPDCCH and Δ_{ARO} is a resource offset of the HARQ-ACK. A value of

$${N}_{PUCCH , q}^{( m 1 )}$$

may be configured to cause the concentrated distribution of the allocated resource indexes.

In an embodiment, the network node may in response to the number of NBs for the PUCCH being equal to or less than a second threshold number, set the value of

$${N}_{PUCCH , q}^{( m 1 )}$$

to be equal to or less than a threshold value.

In an embodiment, the network node may in response to the number of NBs for the PUCCH being greater than the second threshold number, set the value of

$${N}_{PUCCH , q}^{( m 1 )}$$

based on a bitmap index of a USS associated with the transmission of the HARQ-ACK.

In an embodiment, the second communication may comprise a transmission of a scheduling request (SR) on the PUCCH. The network node may determine, from resource indexes for the PUCCH, a different second set of resource indexes available for the transmission of the SR. Then, the network node may allocate, from the second set of resource indexes, a resource index for the transmission of the SR.

In an embodiment, the network node may search for an available resource index in a descending order of resource indexes in the first or second set of resource indexes.

In an embodiment, the second communication may comprise a further transmission of HARQ-ACK on the PUCCH, and a search order of a set of values of Δ_{ARO} is configured to avoid collision between the transmission of the HARQ-ACK and the further transmission of the HARQ-ACK.

In an embodiment, the search order of the set of values of Δ_{ARO} may be set based on

$${n}_{ECCE} + {N}_{PUCCH , q}^{( m 1 )} .$$

In a second aspect of the present disclosure, there is provided a method of a terminal device. In the method, the terminal device performs a first communication with a network node using a plurality of NBs to mitigate collision between the first communication and a different second communication of a terminal device with the network node.

In an embodiment, a resource for the first communication may be allocated in the plurality of NBs to mitigate the collision between the first and second communications.

In an embodiment, the first communication may be performed with a first RIT and the second communication may be performed with a different second RIT.

In an embodiment, at least one NB for the first communication with the first RIT may be allocated in the plurality of NBs. The allocated at least one NB may be separate from at least one NB of the plurality of NBs for a coreset associated with the second RIT. The second communication may be performed on the at least one NB of the plurality of NBs for the coreset.

In an embodiment, the first communication may comprise: a transmission of SI, a transmission of a SIB, or a transmission in a CSS available for a MPDCCH.

In an embodiment, a NB of the plurality of NBs comprises a plurality of resource blocks. An order for searching resource blocks in the at least one NB allocated for the first communication with the first RIT may be reversed from an order for allocating resource blocks of the at least one NBs of the plurality of NBs for the coreset associated with the second RIT.

In an embodiment, the first communication comprises a transmission of SI, and an index of the NB is allocated for the transmission of SI to reduce loss of resources for the second communication.

In an embodiment, the first communication may comprise a transmission in a CSS available for a MPDCCH, and continuous NBs for the transmission in the CSS may be allocated in the plurality of NBs.

In an embodiment, the continuous NBs may be allocated for the transmission in a CSS2. The second communication may comprise: a transmission of SIB1; a transmission of SI; a transmission in a CSS1 for the MPDCCH; a transmission of a synchronization signal; and/or a transmission on a PBCH.

In an embodiment, the first communication may comprise a transmission in a USS for a MPDCCH or a transmission on a PDSCH associated with the MPDCCH. At least one NB for the transmission in the USS for the MPDCCH or the transmission on the PDSCH may be allocated in the plurality of NBs.

In an embodiment, the allocated at least one NB may exclude: a transmission of a synchronization signal; and/or a transmission on a PBCH. The second communication may comprise the transmission of the synchronization signal and/or the transmission on the PBCH.

In an embodiment, the synchronization signal may comprise a PSS and/or an SSS.

In an embodiment, the first communication may be performed with a first RIT, the second communication may comprise a transmission in a coreset associated with a different second RIT. In this embodiment, at least one NB of the plurality of NBs for the coreset may have the lowest priority for allocating the at least one NB for the first communication.

In an embodiment, the coreset may comprise coreset #0.

In an embodiment, the first RIT may comprise category M, and the second RIT comprises LTE or NR.

In an embodiment, the at least one NB allocated for the transmission in the USS for the MPDCCH or the transmission on the PDSCH is reused for: a transmission of SIB1, a transmission of SI, or a transmission in a CSS1 associated with the MPDCCH.

In an embodiment, the at least one NB may be allocated in response to: the transmission in the USS for the MPDCCH or the transmission on the PDSCH being to conflict with the transmission of SIB1 on at least one subframe in the at least one NB to be allocated, and the number of repetitions for the transmission in the USS for the MPDCCH or the transmission on the PDSCH being equal to or greater than a first threshold number.

In an embodiment, the number of repetitions may be increased in response to the number of repetitions for the transmission in the USS being less than the first threshold number and the USS being valid.

In an embodiment, the number of repetitions may be increased in response to the number of repetitions for the transmission on the PDSCH being less than the first threshold number.

In an embodiment, the number of repetitions may be increased to a next higher available number.

In an embodiment, the conflicting at least one subframe may be dropped in response to the number of repetitions for the transmission in the USS for the MPDCCH or on the PDSCH being equal to or greater than the first threshold number, to avoid collision between the transmission in the USS for the MPDCCH or on the PDSCH and the transmission of SIB1 on the MPDCCH.

In an embodiment, the at least one NB may be allocated for the transmission in the USS for the MPDCCH or the transmission on the PDSCH in response to no collision of the transmission in the USS for the MPDCCH or the transmission on the PDSCH with the transmission in the CSS1 on the MPDCCH or the transmission of the SI on the MPDCCH in the at least one NB to be allocated.

In an embodiment, the transmission of the SI may be performed on at least one predetermined subframe and/or in a predetermined frame after cell setup.

In an embodiment, the at least one predetermined subframe may comprise continuous subframes.

In an embodiment, the first communication may be performed on a MPDCCH with repetitions.

In an embodiment, a preamble corresponding to the MPDCCH may be qualified before a starting of the MPDCCH with repetitions. Preamble selection of a terminal device may be blocked in a time interval after the qualification of the preamble and before the starting of the MPDCCH.

In an embodiment, the preamble may be determined to be qualified on a target subframe earlier than a starting subframe of the MPDCCH. In this embodiment, three subframes may be between the target subframe and the starting subframe.

In an embodiment, the MPDCCH may be associated with a first CSS and a different second CSS.

In an embodiment, a first preamble in a first list of preambles associated with the first CSS and a second preamble in a second list of preambles associated with the second CSS may be both qualified before a starting of the MPDCCH. In this embodiment, the first and second preambles correspond to the MPDCCH. A preamble in one of the first and second lists of preambles is blocked in a time interval after the qualification of the first and second preambles and before the starting of the MPDCCH. A CSS of the first and second CSSs associated with the other of the first and second lists may be scheduled in a previous scheduling occasion.

In an embodiment, a first preamble in a first list of preambles associated with the first CSS is qualified before a starting of the MPDCCH, wherein the first preamble corresponds to the MPDCCH. A preamble may be blocked in the first list of preambles in a time interval after the qualification of the first preamble and before the starting of the MPDCCH.

In an embodiment, the blocking may be performed in response to no occasion of a PRACH in the time interval.

In an embodiment, the first and second communications may be performed on a PUCCH.

In an embodiment, the first communication may comprise a transmission of hybrid automatic repeat request-acknowledgement (HARQ-ACK) on the PUCCH. A first set of resource indexes available for the transmission of the HARQ-ACK may be determined from resource indexes for the PUCCH, and a resource index for the transmission of the HARQ-ACK may be allocated from the first set of resource indexes.

In an embodiment, the resource index for the transmission of the HARQ-ACK may be allocated to cause concentrated distribution of resource indexes allocated for transmissions of HARQ-ACK on the PUCCH.

In an embodiment, a resource index for the transmission of the HARQ-ACK may be allocated from the first set of resource indexes as a function of:

$${n}_{PUCCH}^{( 1 , {p}_{0} )} = {n}_{ECCE , q} + {Δ}_{ARO} + {N}_{PUCCH , q}^{( m 1 )} ,$$

$${n}_{PUCCH}^{( 1 , {p}_{0} )}$$

may be the allocated resource index, N_{ECCE} may be the number of the lowest enhanced control channel element (ECCE) indexes used to construct a physical downlink control channel (MPDCCH) and Δ_{ARO} is a resource offset of the HARQ-ACK. A value of

$${N}_{PUCCH , q}^{( m 1 )}$$

may be configured to cause the concentrated distribution of the allocated resource indexes.

In an embodiment, the value of

$${N}_{PUCCH , q}^{( m 1 )}$$

may be equal to or less than a threshold value.

In an embodiment, in response to the number of NBs for the PUCCH being greater than the second threshold number, the value of

$${N}_{PUCCH , q}^{( m 1 )}$$

may be set based on a bitmap index of a user equipment, UE, specific search space, USS, associated with the transmission of the HARQ-ACK.

In an embodiment, the second communication may comprise a transmission of a SR on the PUCCH. A different second set of resource indexes available for the transmission of the SR may be determined from resource indexes for the PUCCH. A resource index for the transmission of the SR may be allocated from the second set of resource indexes.

In an embodiment, an available resource index may be searched for in a descending order of resource indexes in the first or second set of resource indexes.

In an embodiment, the second communication may comprise a further transmission of HARQ-ACK on the PUCCH, and a search order of a set of values of Δ_{ARO} may be configured to avoid collision between the transmission of the HARQ-ACK and the further transmission of the HARQ-ACK.

In an embodiment, the search order of the set of values of Δ_{ARO} may be set based on

$${n}_{ECCE} + {N}_{PUCCH , q}^{( m 1 )} .$$

In a third aspect of the present disclosure, there is provided a network node. The communication device comprises a processor and a memory coupled to the processor, the memory containing instructions executable by the processor, whereby the network node is operative to perform the method according to the first aspect.

In a fourth aspect of the present disclosure, there is provided a terminal device. The terminal device comprises a processor and a memory coupled to the processor, the memory containing instructions executable by the processor, whereby the terminal device is operative to perform the method according to the second aspect.

In a fifth aspect of the present disclosure, there is provided an apparatus. The apparatus comprises means for performing the method according to the first or second aspect.

In a sixth aspect of the disclosure, there is provided a computer-readable storage medium having instructions stored thereon, the instructions, which, when executed by at least one processor of a device, cause the device to perform the method according to the first or second aspect.

With the present disclosure, collision between different communications sharing the plurality of NBs may be avoided, thereby improving communication efficiency, increasing UL and/or DL throughput and improving resource utilization.

### BRIEF DESCRIPTION OF THE DRAWINGS

Through the more detailed description of some embodiments of the present disclosure in the accompanying drawings, the above and other objects, features and advantages of the present disclosure will become more apparent, wherein the same reference generally refers to the same components in the embodiments of the present disclosure.

FIG. 1 is a diagram showing an example communication environment in which embodiments of the present disclosure can be implemented.

FIG. 2A is a diagram showing a flowchart of an example method of conflict management at a network node in accordance with some embodiments of the present disclosure.

FIG. 2B is a diagram showing a flowchart of an example method of resource allocation at a network node in accordance with some embodiments of the present disclosure.

FIG. 3A is a diagram showing example mapping of NBs for SI in a Cat-M system into LTE and NR NBs in a 15 MHz bandwidth in accordance with some embodiments of the present disclosure.

FIG. 3B is a diagram showing example mapping of NBs for SI in a Cat-M system into LTE and NR NBs in a 10 MHz bandwidth in accordance with some embodiments of the present disclosure.

FIG. 3C is a diagram showing an example NB distribution patten in a 15 MHz bandwidths in accordance with some embodiments of the present disclosure.

FIG. 3D is a diagram showing an example NB distribution patten in a 20 MHz bandwidths in accordance with some embodiments of the present disclosure.

FIG. 3E is a diagram showing an example simulation result of the proposed DL resource allocation mechanisms in accordance with some embodiments of the present disclosure.

FIG. 4 is a diagram showing an example allocation of HARQ PUCCH resource indexes in accordance with some embodiments.

FIG. 5 is a diagram showing an example method of resource allocation in accordance with some embodiments of the present disclosure.

FIG. 6A is a diagram showing a timing diagram of a RA procedure in accordance with some embodiments of the present disclosure.

FIG. 6B is a diagram showing an example simulation result of the proposed conflict handing mechanism in accordance with some embodiments of the present disclosure.

FIG. 6C is a diagram showing an example blocking process in accordance with some embodiments of the present disclosure.

FIG. 6D is a diagram showing another example blocking process in accordance with some other embodiments of the present disclosure.

FIG. 7 is a diagram showing a flowchart of an example method of conflict management at a terminal device in accordance with some embodiments of the present disclosure.

FIG. 8 is a block diagram showing a device in accordance with some embodiments.

FIG. 9 is a block diagram showing a computer readable storage medium in accordance with some embodiments.

FIG. 10 is a block diagram showing an example of a communication system in accordance with some embodiments.

FIG. 11 is a block diagram showing a UE in accordance with some embodiments.

FIG. 12 is a block diagram showing a network node in accordance with some embodiments.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As used herein, the term “terminal device” refers to a device which is intended for accessing services via an access network and configured to communicate over the access network. The terminal device may be able to communicate with a network node, such as a base station, or with another terminal device by transmitting and/or receiving wireless signals. For instance, the terminal device may include, but is not limited to: mobile phone, smart phone, sensor device, meter, vehicle, household appliance, medical appliance, media player, camera, or any type of consumer electronic, for instance, but not limited to, television, radio, lighting arrangement, tablet computer, laptop, or PC. The terminal device may also include a portable, pocketstorable, hand-held, computer-comprised, or vehicle-mounted mobile device, enabled to communicate voice and/or data, via a wireless connection. In the following description, the terms “terminal device”, “user equipment” and “UE” may be used interchangeably.

As used herein, the term “network node” refers to a device in a communication network via which a terminal device accesses the network and receives traffic therefrom. Examples of network nodes include, but are not limited to, access points (APs) (e.g., radio access points), base stations (BSs) (e.g., radio base stations, Node Bs, evolved Node Bs (eNBs) and newNR NodeBs (gNBs)).

In the context of the present disclosure, a link from the network node to the terminal device is referred to as a downlink (DL). A link from the terminal device to the network node is referred to as an uplink (UL). A link between two terminal devices is referred to as a sidelink (SL).

As mentioned above, to meet user requirements, multiple NBs are enabled for Cat-M traffic. However, the extension from one NB to multiple NBs may cause resource collision between Cat-M traffic and other traffic.

Certain aspects of the disclosure and their embodiments may provide solutions to these or other challenges. Some embodiments of the present disclosure propose a communication scheme using a plurality of NBs. With the proposed scheme, a network node performs a first communication with a terminal device using a plurality of NBs in a way to mitigate collision between the first communication and a different second communication. The first and second communications may or may not be related to the same terminal device.

Various conflict handling mechanisms can be applied. For example, as will be detailed in the following paragraphs, the conflict handling mechanisms may be related to conflict handling between a user equipment (UE) extended search space (UESS) for a machine type communication (MTC) physical downlink control channel (MPDCCH) (also referred to as MPDCCH UESS)/corresponding physical downlink shared channel (PDSCH) and system information block 1 (SIB1)-BR, between MPDCCH UESS/corresponding PDSCH and system information (SI), between MPDCCH UESS/corresponding PDSCH and paging, and between a type-2 common search space (CSS2) for a MPDCCH (also referred to as MPDCCH CSS2) and Message2 (Msg2) in DL; collision avoidance on a physical uplink control channel (PUCCH) in UL; and/or the like.

The proposed scheme allows a communication using the plurality of NBs to be performed by considering collision avoidance. Thus, collision between different communications sharing the plurality of NBs may be avoided, thereby improving communication efficiency. Moreover, UL and/or DL throughput may be increased, and resource utilization may be improved.

Some example implementations will be described below with reference to the accompanying drawings.

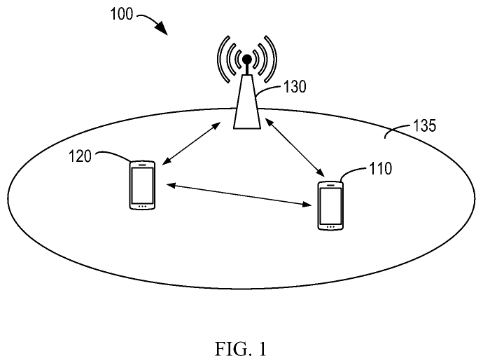

FIG. 1 illustrates an example communication environment 100 in which embodiments of the present disclosure can be implemented.

As shown in FIG. 1, the environment 100 comprises a first terminal device 110 and a second terminal device 120 and a network node 130. In this example, as shown, the first and second terminal devices 110 and 120 are both located within a coverage area 135 of the network node 130 and thus can communicate with each other via the network node 130. The first and second terminal devices 110 and 120 may also communicate with each other directly in a wireless way. Communications in the communication environment 100 may be implemented according to any proper communication protocols and technologies.

It is to be understood that the numbers of devices are illustrated in FIG. 1 only for the purpose of illustration without suggesting any limitations. The communication environment 100 may include any suitable numbers of terminal devices for implementing embodiments of the present disclosure.

The network node 130 can communicate with the first and second terminal devices 110 and 120 on a plurality of NBs in Cat-M, LTE and NR systems. In various embodiments, a first communication is performed by the network node 130 with either the first or second terminal device 110 or 120 using the plurality of NBs in a way to mitigate collision with a different second communication with either the first or second terminal device 110 or 120.

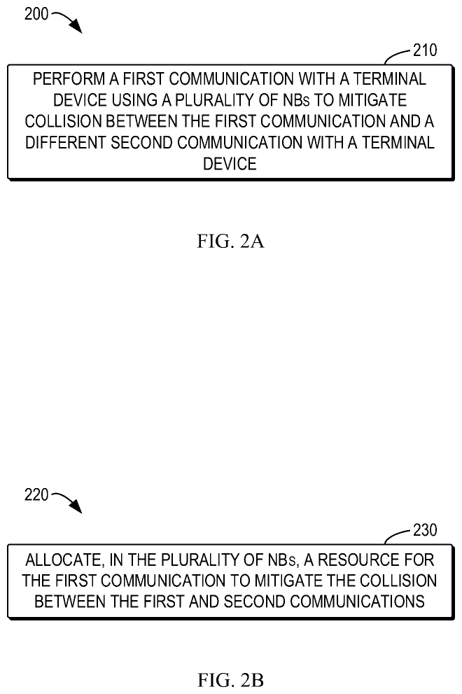

FIG. 2A shows an example method 200 of conflict management according to some embodiments of the present disclosure. The method 200 can be implemented at the network node 130. For the purpose of discussion, the method 200 will be described from the perspective of the network node 130 in FIG. 1.

At block 210, the network node 120 performs a first communication with a terminal device using a plurality of NBs to mitigate collision between the first communication and a different second communication with a terminal device.

The collision mitigation may be achieved by various mechanisms in terms of DL/UL resource allocation and collision resolution. Some embodiments will be detailed below by taking three use cases as examples.

### Example Use Case 1: DL Resource Allocation

In DL, a physical broadcast channel (PBCH), a MPDCCH and PDSCH in a Cat-M system may share the same NBs which are also used for LTE and NR transmissions. In some embodiments, DL resource allocation mechanisms may be used to avoid collision between various DL transmissions, for example, related to a synchronization signal such as a primary synchronization signal (PSS) and a secondary synchronization signal (SSS), SI, a system information block (SIB), a MPDCCH and/or a PDSCH.

Some embodiments in this regard will be discussed below with refence to FIGS. 2B to 4.

FIG. 2B shows an example method 230 of resource allocation according to some embodiments of the present disclosure. The method 230 can be implemented at the network node 130. For the purpose of discussion, the method 230 will be described from the perspective of the network node 130 in FIG. 1.

At block 240, the network node 120 allocates, in the plurality of NBs, a resource for the first communication to mitigate the collision between the first and second communications. The resource may comprise a resource in both time and frequency domains. In some embodiments, the first and second communications may be DL communications. The two communications may utilize different radio interface technologies (RITs). For example, the network node 130 may perform the first communication with a first RIT such as Cat-M, and perform the second communication with a different second RIT such as LTE or NR. As such, collision may be mitigated between communications using different RITs.

In some embodiments, in the case that the first communication with the first RIT shares the plurality of NBs with the second communication with the second RIT, the network node 120 may allocate at least one NB of the plurality of NBs for the first communication in a way that the allocated NB is separate from at least one NB of the plurality of NBs for the second communication.

In some embodiments, the second communication may comprise a communication performed in a coreset occupying the at least one NB. The coreset may occupy a plurality of PRBs in a frequency domain and a plurality of orthogonal frequency-division multiplexing (OFDM) symbols in a time domain. In an embodiment, the coreset may comprise Coreset #0. As an example, in the case of an extended search space (ESS), Coreset #0 may occupy 48 PRBs from PRB index 0 to 47 in NR. In this way, the first communication with the first RIT such as Cat-M may not interfere the coreset related to the second RIT, thereby reducing impact on the communications with the second RIT such as LTE or NR. Thus, the overall reliability of communications with the second RIT may be improved.

In some embodiments, the first communication subject to conflict management may comprise a transmission of SI, a transmission of a SIB, and/or a transmission in a common search space (CSS) available for a MPDCCH. In an example, the SI may be allocated with a plurality of resource blocks (RBs) such as 6 PRBs (e.g., 1 full NB). The location of the SIB (such as SIB1) may be related with a cell identification (ID) and a DL bandwidth.

In some embodiments, a NB of the plurality of NBs may comprise a plurality of resource blocks (RBs), and an order for searching RBs in the at least one NB allocated for the first communication with the first RIT may be reversed from an order for allocating RBs of the at least one NBs for the coreset associated with the second RIT. In this way, the NBs for the first and second communications may be allocated from opposite boundaries of a frequency range formed by the plurality of NBs, thereby further reducing the collision probability.

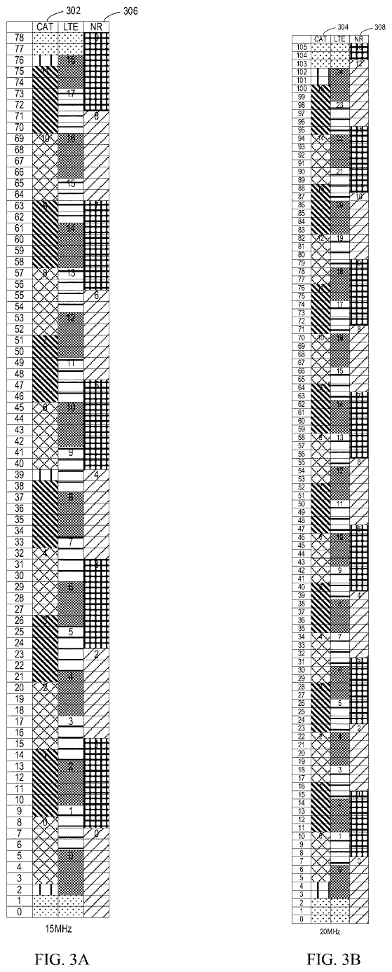

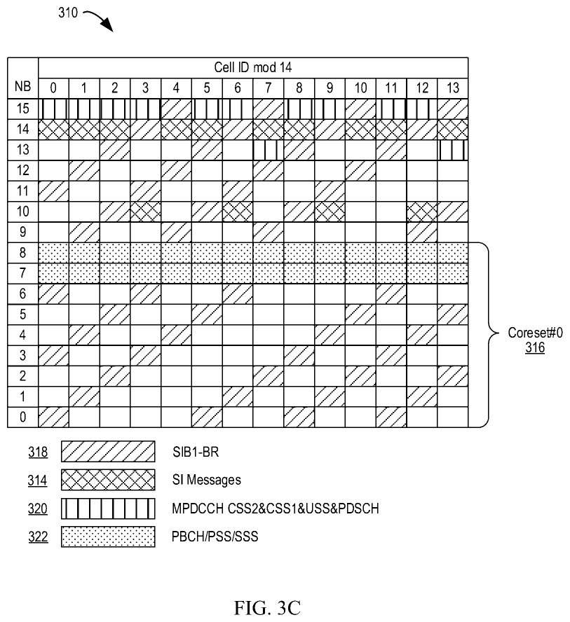

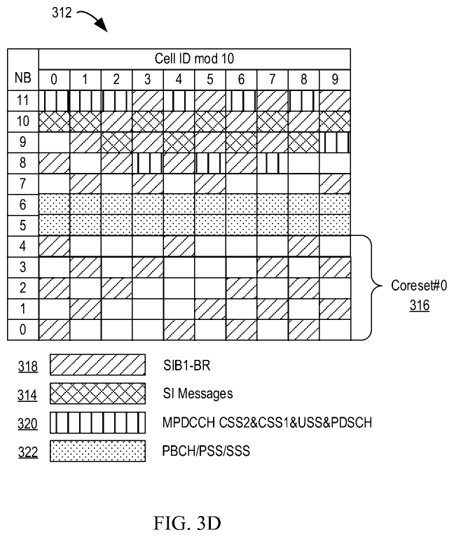

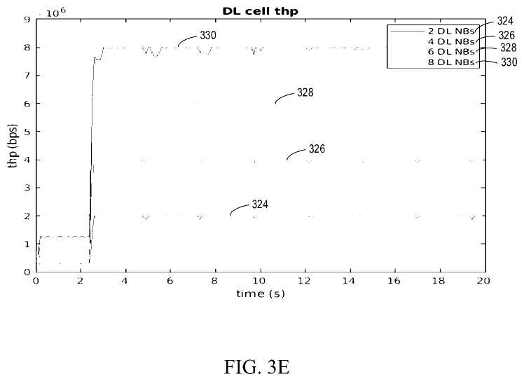

In some embodiments, in the case that the first communication comprises a transmission of SI (or “SI transmission”), an index of the NB is allocated for the SI transmission to reduce loss of resources for the second communication. In an example, in the embodiments where the SI is used for a Cat-M system, an index of the NB allocated for the transmission of SI may be a secondary high index of the plurality of NBs, as shown in FIGS. 3A and 3B. In this way, Cat-M NB allocation may take the LTE/NR downlink characteristics into consideration in case of co-exist with LTE/NR, and thus the collision between Cat-M and LTE/NR systems may be further mitigated and impact on LTE/NR may be further reduced.

FIGS. 3A and 3B show example mapping of NBs for SI in a Cat-M system into LTE and NR NBs in 15 MHz and 10 MHz bandwidths in accordance with some embodiments of the present disclosure.

In a 15 MHz bandwidth as shown in FIG. 3A, if the secondary high index #10 (15 MHz) or #14 (20 MHz) of a resource block group (RBG) is allocated for SI in Cat-M (“CAT” 302 or 304), the SI transmission may impact only one NB index #8 or #11 of RBGs in NR 306 or 308, and therefore the impact on the NR system may be further reduced. A NR RBG may comprise different numbers of RBs in different systems. Similar scenarios occur in a 20 MHz bandwidth as shown in FIG. 3B.

In some embodiments, the first communication may comprise a transmission in a CSS available for a MPDCCH. In these embodiments, the network node 130 may allocate, in the plurality of NBs, continuous NBs for the transmission in the CSS. The CSS may comprise a Type-0 common search space (CSS0), a Type-1 common search space (CSS1) and/or a Type-2 common search space (CSS2).

In the embodiments where the first communication comprises a transmission in a CSS2 available for a MPDCCH (or “MPDCCH CSS2”), the second communication may comprise a transmission of SIB1, a transmission of SI, a transmission in a CSS1 for the MPDCCH (or “MPDCCH CSS1”), a transmission of a synchronization signal such as a PSS and an SSS; and/or a transmission on a PBCH. Both the first and second communications may be performed in a Cat-M system. As such, intra-system collision may be reduced.

In some embodiments, the first communication may comprise a transmission in a UE specific search space (USS), such as a UE extended search space (UESS), for a MPDCCH or a transmission on a PDSCH associated with the MPDCCH. In these embodiments, the network node 130 may allocate, in the plurality of NBs, at least one NB for the transmission in the USS for the MPDCCH (or “MPCCH USS”) or the transmission on the PDSCH.

In an example, in the embodiments where the first communication comprises a transmission in a MPCCH USS, the second communication may comprise a transmission of a synchronization signal such as a PSS and an SSS; and/or a transmission on a PBCH. In an example, the at least one NB allocated for the MPDCCH USS may exclude a NB for a transmission of the synchronization signal and/or a NB for a transmission on the PBCH.

In some embodiment, in the case that the first communication comprises a transmission in a MPDCCH USS, the second communication may comprise a transmission in a coreset such as Coreset #0. In this case, at least one NB of the plurality of NBs for the coreset may have the lowest priority for allocating at least one NB for the transmission in the MPDCCH USS to further reduce the collision probability.

In some embodiment, the at least one NB allocated for the transmission in the USS for the MPDCCH or the transmission on the PDSCH may reused for a transmission of SIB1, a transmission of SI and/or a transmission in a CSS1 on the MPDCCH.

An example DL resource allocation mechanism will be discussed below with reference to FIGS. 3C and 3D.

FIGS. 3C and 3D show example NB distribution pattens 310 and 312 in 15 MHz and 20 MHz bandwidths in accordance with some embodiments of the present disclosure.

In the example NB distribution pattens 310 as shown in FIG. 3C and the example NB allocation pattens 312 as shown in FIG. 3D, NBs 314 are allocated to SI messages in non-CORESET #0 area (e.g., outside of an area 316 for CORESET #0, or “CORESET #0 area”), for example, with one NR RBG to reduce the impact on NR. In addition, the search order of NBs for SI (or “SI NBs”) may be reversed from the allocation order of PRBs in NR. Moreover, the SI NBs may not collide with NB(s) 318 for SIB1-BR. As an example, in NR deployment as shown in FIG. 3C, the CORESET #0 area 316 occupies 48 PRBs from PRB index 0 to 48 where PRB is allocated from low index to high index. In this case, NBs 314 are assigned to SI.

Based on the number of configured CSS2, continuous NBs 320 may be searched in non-CORESET #0 area (excluding NBs 322 for PBCH/PSS/SSS) and the search order may be reversed from the allocation order in NR. NBs 320, which may be used for MPDCCH CSS2, may reused for SIB1-BR, SI and MPDCCH CSS1, for example, with no collision.

For MPDCCH UESS/PDSCH, NBs 322 used for PBCH/PSS/SSS may be excluded, and NBs 320 used for SIB1-BR/SI MPDCCH CSS1 may be included. In addition, the CORESET #0 area 316 may have the lowest priority for MPDCCH UESS/PDSCH.

In some embodiments, in the scenario that NBs are reused by MPDCCH USS/PDSCH and SIBI such as SIB1-BR, to allocate the NBs to MPDCCH USS, the network node 130 may determine whether the transmission in the USS for the MPDCCH or the transmission on the PDSCH is to conflict with the transmission of SIBI on at least one subframe in the at least one NB to be allocated. If so, the network node 130 may determine whether the number of repetitions for the transmission in the USS for the MPDCCH or the transmission on the PDSCH is large enough, which means that the MPDCCH USS/PDSCH may be more robust. Then, the network node 130 may allocate the at least one NB for the transmission in the USS for the MPDCCH or the transmission on the PDSCH.

The network node 130 may compare the number of repetitions for the transmission in the USS for the MPDCCH or the transmission on the PDSCH (also referred to as the number of repetitions for MPDCCH USS or for PDSCH) with a first threshold number that may be set depending on network deployments and practical requirements.

In some embodiments, if the number of repetitions for MPDCCH USS or for PDSCH is equal to or greater than the first threshold number, the network node 130 may drop the conflicting at least one subframe to avoid collision between the transmission in the USS for the MPDCCH or on the PDSCH and the transmission of SIB1.

In some embodiments, if the number of repetitions for MPDCCH USS is less, for example, than the first threshold number, the network node 130 may not schedule a terminal device (such as the first terminal device 110) to use the MPDCCH USS, but schedule another terminal device (such as the second terminal device 120).

By way of example, if the number of repetitions for MPDCCH UESS<4 (as an example of the first threshold number) through MPDCCH link adaptation (LA) and there is conflicting subframes with SIB1-BR during the MPDCCH transmission, the network node 130 then may not schedule the corresponding terminal device and select another terminal device.

In some embodiments, the conflict handling may consider USS validity. In an example, if the number of repetitions for the transmission in the USS is less than the first threshold number, the network node 130 may determine whether the USS is valid (for example, available). If the USS is invalid, the network node 130 may drop a schedule of the corresponding terminal device.

If the USS is valid, the network node 130 may increase the number of repetitions, for example, to a next higher available number or another available higher number to improve the transmission reliability and resource utilization.

By way of example, if the number of repetitions for the MPDCCH UESS<4, the network node 130 may check the USS. If the USS is valid, the network node 130 may increase the number of MPDCCH repetitions. Otherwise, the network node 130 does not schedule the current terminal device and select another terminal device. If the MPDCCH UESS>4, the network node 130 may drop the conflicting subframes for the MPDCCH UESS.

For the transmission on the PDSCH, Table 1 shows an example configuration of repetitions for a PDSCH (or PDSCH repetitions).

TABLE 1

| Higher layer parameter | |
|---|---|
| ‘pdsch-maxNumRepetitionCEmodeA’ | {n1, n2, n3, n4} |
| Not configured | {1, 2, 4, 8} |
| 16 | {1, 4, 8, 16} |
| 32 | {1, 4, 16, 32) |

As shown in Table 1, if the higher layer parameter pdsch-maxNumRepetitionCEmodeA is not configured, the number of the PDSCH repetitions is set to be {1,2,4,8}. If this parameter is configured to be 16, the number of the PDSCH repetitions is set to be {1,4,8,16}. If this parameter is configured to be 32, the number of the PDSCH repetitions is set to be {1,4,16,32}.

By way of example, for conflict handling between PDSCH and SIB1-BR, if PDSCH repetition <4 through PDSCH LA and there is conflicting subframes with SIB1-Br during PDSCH transmission, then the network device 130 may increase the number of the PDSCH repetitions toa next higher available value as shown in Table 1, for example. Otherwise, PDSCH conflicting subframes may be dropped.

In some embodiments, in the scenario that NBs are reused by MPDCCH USS/PDSCH, SI and MPDCCH CSS1, the network node 130 may determine whether there is collision of the transmission in the USS for the MPDCCH or the transmission on the PDSCH with the transmission in the CSS1 on the MPDCCH or the transmission of the SI in the at least one NB to be allocated. If there is no collision, the network node 130 may allocate the at least one NB for MPDCCH USS or for PDSCH. In an embodiment, if MPDCCH USS/PDSCH is collision with MPDCCH CSS1 and PDSCH is used for paging, then the network node 130 may not schedule the corresponding terminal device and select another terminal device.

In some embodiments, the transmission of the SI may be performed on at least one predetermined subframe and/or in a predetermined frame after cell setup to further avoid collision. In an example, the at least one predetermined subframe may comprise continuous subframes.

By way of example, for conflict handling between MPDCCH UESS/corresponding PDSCH and SI, SI may be sent in a fixed subframe and frame after cell setup and may be sent in continuous subframes on some frames. In the case that SI is fixed and reserved, if MPDCCH USS/PDSCH is collision with SI, then the network node 130 may not schedule the corresponding termina device and select another termina device.

The simulation results show that with the proposed DL resource allocation mechanisms as described above, the DL communication efficiency may be improved. The employed simulation configuration is shown in Table 2.

TABLE 2

| | Configuration | | | | | |
|---|---|---|---|---|---|---|
| | | No. | | | | |
| Cell | No. UESS | CSS2 | noOfPusch | Traffic | | |
| throughput | NBs | NBs | NbBr | model | BW | Simulation results |
| DL | 2 | 2 | 4 | full buffer | 15 MHz | 2.0 Mbps |
| | 4 | 2 | 4 | full buffer | 15 MHz | 4.0 Mbps |
| | 2 | 2 | 4 | full buffer | 20 MHz | 2.0 Mbps |
| | 4 | 2 | 4 | full buffer | 20 MHz | 4.0 Mbps |
| | 4 | 2 | 6 | full buffer | 20 MHz | 4.0 Mbps |
| | 6 | 2 | 6 | full buffer | 20 MHz | 6.0 Mbps |
| | 6 | 2 | 8 | full buffer | 20 MHz | 6.0 Mbps |
| | 8 | 2 | 8 | full buffer | 20 MHz | 8.0 Mbps |

FIG. 3E shows an example simulation result of the proposed DL resource allocation mechanisms in accordance with some embodiments of the present disclosure.

As shown in FIG. 3E, with the proposed DL resource allocation mechanisms, the DL cell throughput 324, 326, 328 and 340 may be enhanced in the case of 2 DL NBs, 4 DL NBs, 6 DL NBs and 8 DL NBs.

### Example Use Case 2: UL Resource Allocation

In some embodiments, the first and second communications subject to conflict management may both be UL communications. In an example, the first and second communications may be performed on a PUCCH. Some UL resource allocation mechanisms may be employed to avoid the collision between the transmissions on the PUCCH.

In some embodiments, the first communication may comprise a transmission of hybrid automatic repeat request-acknowledgement (HARQ-ACK) on the PUCCH. In this case, the network node 130 may determine, from resource indexes for the PUCCH, a first set of resource indexes available for the transmission of the HARQ-ACK. Then, the network node 130 may allocate a resource index for the transmission of the HARQ-ACK from the first set of resource indexes.

In some embodiments, the second communication may comprise a transmission of a scheduling request (SR) on the PUCCH. In these embodiments, the network node 130 may determine, from resource indexes for the PUCCH, a second set of resource indexes available for the transmission of the SR. From the first set of resource indexes, the network node 130 may allocate a resource index for the transmission of the SR.

In some embodiments, the first and second sets of resource indexes for HARQ-ACK and SR may be separate from each other to further reduce collision. For example, the HARQ-ACK (A/N) may be allocated from index #0 to #38, and SR may be allocated from #71 to #39.

In some embodiments, to allocate a resource index for the transmission of the SR and/or HARQ-ACK, the network node 130 may search for an available resource index in a descending order of resource indexes in the first or second set of resource indexes to further reduce the collision probability. For example, a PUCCH resource index may be shared between HARQ-ACK (A/N) and SR. Searching may be started from the highest possible index, and the first free (or available) index may be assigned to the corresponding terminal device to further reduce the collision between SR and HARQ-ACK.

In some embodiments, the resource index for the transmission of the HARQ-ACK may be allocated to cause concentrated distribution of resource indexes allocated for transmissions of HARQ-ACK on the PUCCH. In an example, a resource index may be determined as a function of:

$${n}_{PUCCH}^{( 1 , {p}_{0} )} = {n}_{ECCE , q} + {Δ}_{ARO} + {N}_{PUCCH , q}^{( m 1 )} , \qquad ( 1 )$$

where

$${n}_{PUCCH}^{( 1 , {p}_{0} )}$$

is the allocated resource index, N_{ECCE} is the number of the lowest enhanced control channel element (ECCE) indexes used to construct a MPDCCH, and Δ_{ARO} is a resource offset of the HARQ-ACK. A value of

$${N}_{PUCCH , q}^{( m 1 )}$$

may be configured to cause the concentrated distribution of the allocated resource indexes.

In some embodiments, the network node 130 may determine whether the number of NBs for the PUCCH is smaller, for example, equal to or less than a second threshold number which may be set depending on the network deployments and practical requirements. If the number of NBs for the PUCCH is smaller, the network node 130 may set the value of

$${N}_{PUCCH , q}^{( m 1 )}$$

to be equal to or less than a threshold value to concentrate the allocated resource indexes.

In some embodiments, if the number of NBs for the PUCCH is greater than the second threshold number, the network node 130 may set the value of

$${N}_{PUCCH , q}^{( m 1 )}$$

based on a bitmap index of a USS associated with the transmission of the HARQ-ACK.

In an example, if noOfMpdcchUessBr (which indicates the number of the NBs for the PUCCH) is small, the used NB(s) may be limited into a small range. For example, if noOfMpdcchUessBr≤4, then the network node 130 may select the N1PUCCH−AN value, which indicates the value of

$${N}_{PUCCH , q}^{( m 1 )} ,$$

with 2 for coverage enhancement level 0 (CE0) and 15 for coverage enhancement level 1 (CE1).

If noOfMpdcchUessBr>4, the N1PUCCH−AN value may be determined according to allocated NBs for UESS for this new connection. If the UeSSNB bitmap index, allocated to new connection, is between 1 and Ceiling(noOfMpdcchUessBr/2), then the network node 130 may select the N1PUCCH−AN value with 2 for CE0 and 15 for CE1. Otherwise, the network node 130 may select the N1PUCCH−AN value with 20 for CE0 and 33 for CE1.

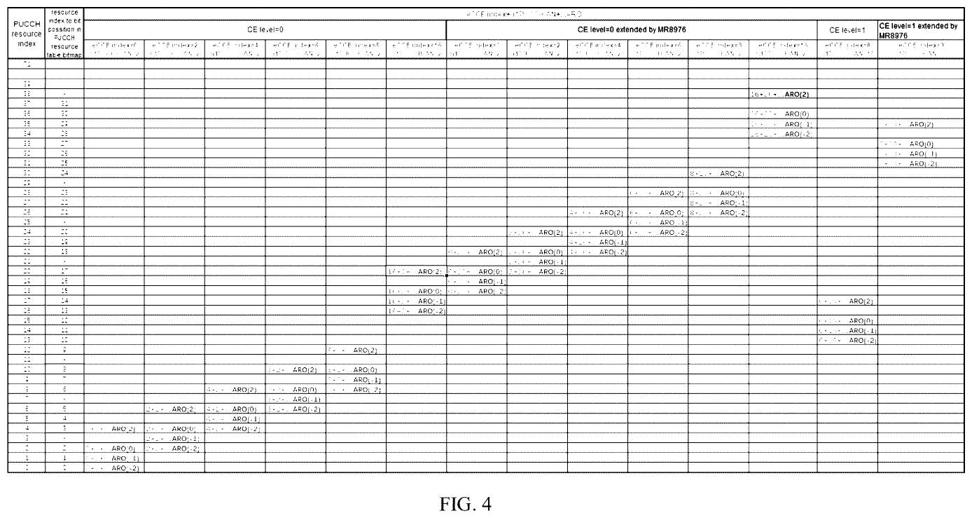

FIG. 4 shows an example allocation of HARQ PUCCH resource indexes in accordance with some embodiments. As shown in FIG. 4, based on different N1PUCCH−AN values, HARQ PUCCH resource indexes may be concentratedly distributed.

In some embodiments, the second communication may comprise a further transmission of HARQ-ACK on the PUCCH. In these embodiments, a search order of a set of values of Δ_{ARO} may be configured to avoid collision between the transmission of the HARQ-ACK and the further transmission of the HARQ-ACK.

In some embodiments, the search order of the set of values of Δ_{ARO} may be set based on

$${n}_{ECCE} + {N}_{PUCCH , q}^{( m 1 )} .$$

In an example, for Δ_{ARO} offsets optimization, Δ_{ARO} offsets may be searched depending on N_{ECCE}+N1PUCCH−AN as below:

$$( 0 , - 1 , - 2 , 2 ) for {n}_{ECCE} + N 1 PUCCH - AN ∈ \{ 2 , 15 , 18 \} or \{ 20 , 22 , 26 \} ,$$

$$( 0 , - 1 , 2 , - 2 ) for {n}_{ECCE} + N 1 PUCCH - A N ∈ \{ 4 , 6 , 8 , 10 \} or \{ 22 , 24 , 26 , 28 \} .$$

By the design of the search order of Δ_{ARO} offsets, the collision probability between two transmissions of HARQ-ACK on the PUCCH may be further reduced.

### Example Use Case 3: Conflict Handling Between MPDCCH CSS2 and Msg2

In a random access (RA) procedure, a starting subframe of a MPDCCH with repetitions may be occupied by message2 (Msg2) corresponding to a MPDCCH with no repetition. Accordingly, transmissions on the MPDCCH with repetitions may be blocked by Msg2. In this case, the network node 130 may have to wait to a next schedule occasion for a MPDCCH with repetitions, which may cause a long delay for the MPDCCH with repetitions.

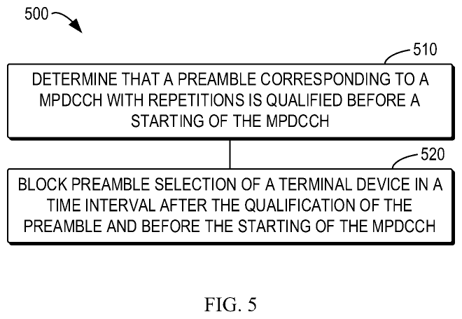

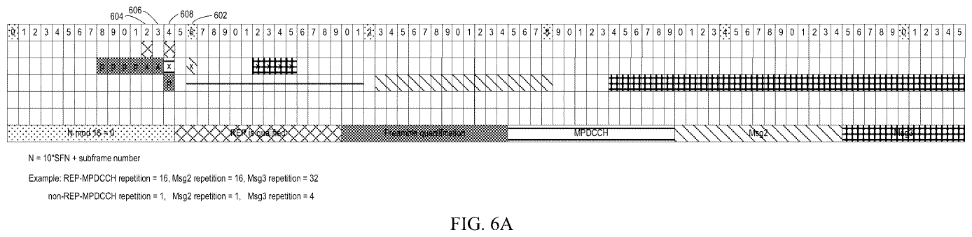

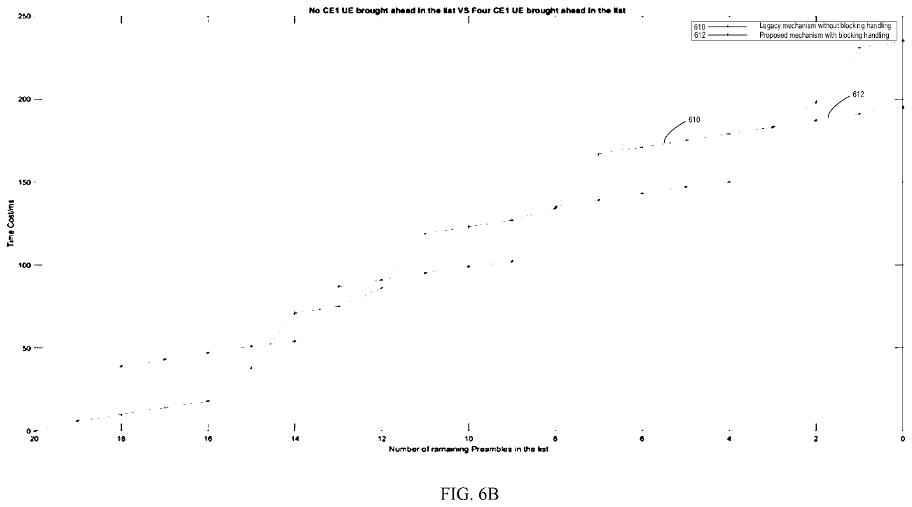

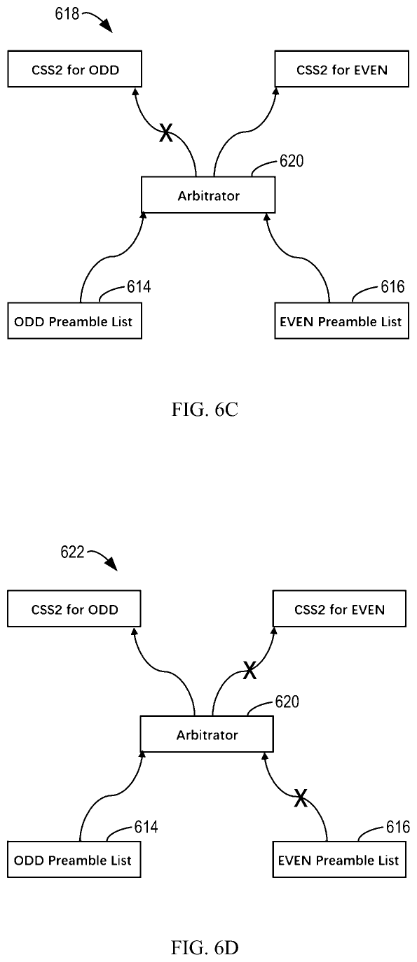

In some embodiments, conflict handing mechanisms may be employed to avoid resource collision between the MPDCCH with the repetitions and Msg2 to improve resource utilization. Some embodiments in this regard will be discussed below with refence to FIGS. 5 to 6D.

FIG. 5 shows an example method 500 of resource allocation according to some embodiments of the present disclosure. The method 500 can be implemented at the network node 130. For the purpose of discussion, the method 500 will be described from the perspective of the network node 130 in FIG. 1.

At block 510, the network node 130 determines that a preamble corresponding to a MPDCCH with repetitions is qualified before a starting of the MPDCCH. At block 520, the network node 130 blocks preamble selection of a terminal device in a time interval after the qualification of the preamble and before the starting of the MPDCCH.

In some embodiments, the preamble qualification may be determined on a target subframe earlier than a starting subframe of the MPDCCH with repetitions. In an example, three subframes are between the target subframe and the starting subframe.

By way of example, preambles corresponding to the MPDCCH with repetitions may be put to a qualification procedure on a subframe N−4, where N is a positive integer greater than 4 and represents a number of a starting subframe of the MPDCCH with repetitions. In an example, N may satisfy the following equation:

$$N mod T mpdcch = 0 , \qquad ( 2 )$$

where N=10*SFN+subframe number, T mpdcch=mpdcch-NumRepetition-RA-r13*G. mpdcch-NumRepetition-RA-r13 is a higher layer parameter such as radio resource control (RRC) parameter to indicate the number of the repetitions for MPDCCH. G is a system parameter. SFN represents a system frame number.

If the preambles are qualified on the subframe N−4, preamble selection on subframes N−4 and N−3 may be blocked. If no preamble is qualified, the preamble selection works as usual.

In some embodiments, the blocking of the preamble selection may consider an occasion of a physical random access channel (PRACH), also called a PRACH occasion. For example, the blocking is performed in response to no PRACH occasion in the time interval after the qualification of the preamble and before the starting of the MPDCCH.

FIG. 6A shows a timing diagram of a RA procedure in accordance with some embodiments of the present disclosure. In this example, the number of MPDCCH repetitions is 16, the number of Msg2 repetitions is 16, and the number of Message3 (Msg3) repetitions is 32.

As shown in FIG. 6A, a subframe 602 (e.g., Subframe #6) is a starting subframe of a MPDCCH with repetitions. On a subframe 604 (e.g., Subframe #2), a qualification procedure is performed, and a preamble is determined to be qualified. Moreover, the network node 130 may predict that there is no PRACH occasion at the latter two subframes 606 and 608 (e.g., Subframes #3 and #4). In this case, the latter two subframes 606 and 608 are blocked for preamble selection. Then, on the subframe 608 (e.g., Subframe #4), the preamble is qualified again. Accordingly, from the subframe 602 (e.g., Subframe #6), transmissions are initiated on the MPDCCH with repetitions.

FIG. 6B shows an example simulation result of the proposed conflict handing mechanism in accordance with some embodiments of the present disclosure.

As shown in FIG. 6B, with the proposed mechanism with blocking handling, a time length for processing 20 preambles is shorter than a legacy mechanism without blocking handing by 40 ms.

In some scenarios, the MPDCCH with repetitions may be associated with two different CSSs (such as CSS2), referred to as a first CSS and a second CSS, respectively. In these scenarios, the preambles may be divided into two lists of preambles to associated with the first and second CSSs, respectively. For the purpose of discussion, the two lists of preambles may be referred to as a first list of preambles and a second list of preambles, respectively. In an example, the first list of preambles may include odd preambles, and the second list of preambles may include even preambles.

In some embodiments, for the MPDCCH with repetitions, the network node 130 may determine whether a first preamble in the first list of preambles and a second preamble in the second list of preambles are both qualified before a starting of the MPDCCH. In the case that both the first and second preambles are qualified, the network node 130 may block a preamble in one of the first and second lists of preambles in a time interval after the qualification of the first and second preambles and before the starting of the MPDCCH if a CSS of the first and second CSSs associated with the other of the first and second lists is scheduled in a previous scheduling occasion.

In some embodiments, if the network node 130 determines that a first preamble in the first list of preambles is qualified before a starting of the MPDCCH with repetitions, the network node 130 may block a preamble in the first list of preambles in a time interval after the qualification of the first preamble and before the starting of the MPDCCH. In some embodiments, the blocking may also consider a PRACH occasion in the time interval.

Example blocking processes will be discussed below with reference to FIGS. 6C and 6D. In these examples, preambles are split to two list, one list (as an example of the first list, also referred to as “an odd preamble list 614”) for odd preambles and the other (as an example of the second list, also referred to as “an even preamble list 616”) for even preambles. It is assumed that a CSS (for example, CSS2) associated with the list of odd preambles (which may be also referred to as a previous preamble list) is scheduled in a previous scheduling occasion.

In a process 618 as shown in FIG. 6C, for both of two preamble lists, at an arbitrator 620 of the network node 130, it may be determined that a preamble corresponding to a MPDCCH with repetitions is qualified on a subframe N−4 and there is no PRACH occasion in subframe N−3 and N−2. Then, preamble blocking on subframes N−4 and N−3 may be performed for the opposite preamble list which is the even preamble list 616. The opposite preamble list may be chosen on a subframe N−2 for scheduling.

In a process 622 as shown in FIG. 6D, at the arbitrator 620, it may be determined that a preamble is qualified on a subframe N−4 and there is no PRACH occasion in subframe N−3 and N−2 for one (assuming the odd preamble list) of two preamble lists. Then, preamble blocking on subframes N−4 and N−3 may be performed for the odd preamble list 614. The odd preamble list 614 is chosen on the subframe N−2.

In some embodiments, for preamble selection for preambles corresponding to a MPDCCH with no repetitions, an opposite preamble list against the previous preamble list may be chose for scheduling.

With the proposed conflict handling mechanisms for a MPCCH with repetitions, a successful rate of a random access successful rate may be improved. Moreover, CSS (e.g., CSS2) resource efficiency may be improved.

### Example Method of Terminal Device

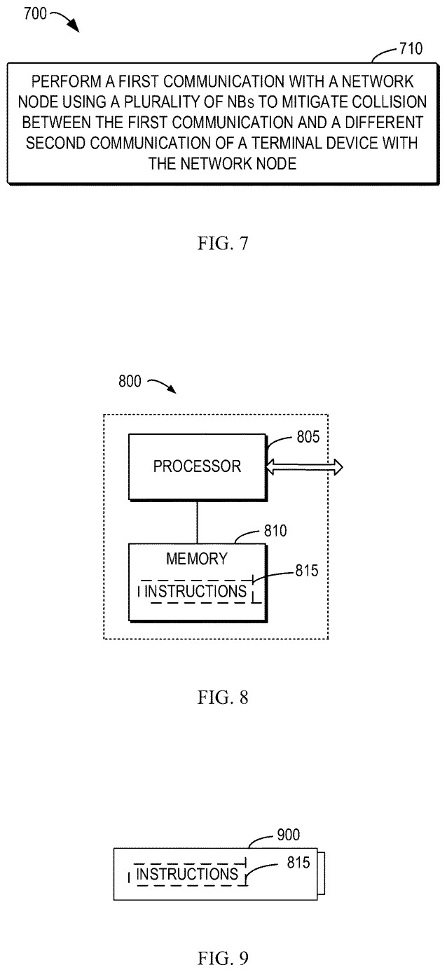

FIG. 7 shows a flowchart of an example method 700 of conflict management implemented at a terminal device (such as the first terminal device 110 or the second terminal device 120) in accordance with some embodiments of the present disclosure. For the purpose of discussion, the method 500 will be described from the perspective of the first terminal device 110 in FIG. 1.

At block 710, the first terminal device performs a first communication with a network node using a plurality of NBs to mitigate collision between the first communication and a different second communication of a terminal device with the network node.

In an embodiment, a resource for the first communication may be allocated in the plurality of NBs to mitigate the collision between the first and second communications.

In an embodiment, the first communication may be performed with a first RIT and the second communication may be performed with a different second RIT.

In an embodiment, at least one NB for the first communication with the first RIT may be allocated in the plurality of NBs. The allocated at least one NB may be separate from at least one NB of the plurality of NBs for a coreset associated with the second RIT. The second communication may be performed on the at least one NB of the plurality of NBs for the coreset.

In an embodiment, the first communication may comprise: a transmission of SI, a transmission of a SIB, or a transmission in a CSS available for a MPDCCH.

In an embodiment, a NB of the plurality of NBs comprises a plurality of resource blocks. An order for searching resource blocks in the at least one NB allocated for the first communication with the first RIT may be reversed from an order for allocating resource blocks of the at least one NBs of the plurality of NBs for the coreset associated with the second RIT.

In an embodiment, the first communication comprises a transmission of SI, and an index of the NB is allocated for the transmission of SI to reduce loss of resources for the second communication.

In an embodiment, the first communication may comprise a transmission in a CSS available for a MPDCCH, and continuous NBs for the transmission in the CSS may be allocated in the plurality of NBs.

In an embodiment, the continuous NBs may be allocated for the transmission in a CSS2. The second communication may comprise: a transmission of SIB1; a transmission of SI; a transmission in a CSS1 for the MPDCCH; a transmission of a synchronization signal; and/or a transmission on a PBCH.

In an embodiment, the first communication may comprise a transmission in a USS for a MPDCCH or a transmission on a PDSCH associated with the MPDCCH. At least one NB for the transmission in the USS for the MPDCCH or the transmission on the PDSCH may be allocated in the plurality of NBs.

In an embodiment, the allocated at least one NB may exclude: a transmission of a synchronization signal; and/or a transmission on a PBCH. The second communication may comprise the transmission of the synchronization signal and/or the transmission on the PBCH.

In an embodiment, the synchronization signal may comprise a PSS and/or an SSS.

In an embodiment, the first communication may be performed with a first RIT, the second communication may comprise a transmission in a coreset associated with a different second RIT. In this embodiment, at least one NB of the plurality of NBs for the coreset may have the lowest priority for allocating the at least one NB for the first communication.

In an embodiment, the coreset may comprise coreset #0.

In an embodiment, the first RIT may comprise category M, and the second RIT comprises LTE or NR.

In an embodiment, the at least one NB allocated for the transmission in the USS for the MPDCCH or the transmission on the PDSCH is reused for: a transmission of SIB1, a transmission of SI, or a transmission in a CSS1 associated with the MPDCCH.

In an embodiment, the at least one NB may be allocated in response to: the transmission in the USS for the MPDCCH or the transmission on the PDSCH being to conflict with the transmission of SIBI on at least one subframe in the at least one NB to be allocated, and the number of repetitions for the transmission in the USS for the MPDCCH or the transmission on the PDSCH being equal to or greater than a first threshold number.

In an embodiment, the number of repetitions may be increased in response to the number of repetitions for the transmission in the USS being less than the first threshold number and the USS being valid.

In an embodiment, the number of repetitions may be increased in response to the number of repetitions for the transmission on the PDSCH being less than the first threshold number.

In an embodiment, the number of repetitions may be increased to a next higher available number.

In an embodiment, the conflicting at least one subframe may be dropped in response to the number of repetitions for the transmission in the USS for the MPDCCH or on the PDSCH being equal to or greater than the first threshold number, to avoid collision between the transmission in the USS for the MPDCCH or on the PDSCH and the transmission of SIB1 on the MPDCCH.

In an embodiment, the at least one NB may be allocated for the transmission in the USS for the MPDCCH or the transmission on the PDSCH in response to no collision of the transmission in the USS for the MPDCCH or the transmission on the PDSCH with the transmission in the CSS1 on the MPDCCH or the transmission of the SI on the MPDCCH in the at least one NB to be allocated.

In an embodiment, the transmission of the SI may be performed on at least one predetermined subframe and/or in a predetermined frame after cell setup.

In an embodiment, the at least one predetermined subframe may comprise continuous subframes.

In an embodiment, the first communication may be performed on a MPDCCH with repetitions.

In an embodiment, a preamble corresponding to the MPDCCH may be qualified before a starting of the MPDCCH with repetitions. Preamble selection of a terminal device may be blocked in a time interval after the qualification of the preamble and before the starting of the MPDCCH.

In an embodiment, the preamble may be determined to be qualified on a target subframe earlier than a starting subframe of the MPDCCH. In this embodiment, three subframes may be between the target subframe and the starting subframe.

In an embodiment, the MPDCCH may be associated with a first CSS and a different second CSS.

In an embodiment, a first preamble in a first list of preambles associated with the first CSS and a second preamble in a second list of preambles associated with the second CSS may be both qualified before a starting of the MPDCCH. In this embodiment, the first and second preambles correspond to the MPDCCH. A preamble in one of the first and second lists of preambles is blocked in a time interval after the qualification of the first and second preambles and before the starting of the MPDCCH. A CSS of the first and second CSSs associated with the other of the first and second lists may be scheduled in a previous scheduling occasion.

In an embodiment, a first preamble in a first list of preambles associated with the first CSS is qualified before a starting of the MPDCCH, wherein the first preamble corresponds to the MPDCCH. A preamble may be blocked in the first list of preambles in a time interval after the qualification of the first preamble and before the starting of the MPDCCH.

In an embodiment, the blocking may be performed in response to no occasion of a PRACH in the time interval.

In an embodiment, the first and second communications may be performed on a PUCCH.

In an embodiment, the first communication may comprise a transmission of hybrid automatic repeat request-acknowledgement (HARQ-ACK) on the PUCCH. A first set of resource indexes available for the transmission of the HARQ-ACK may be determined from resource indexes for the PUCCH, and a resource index for the transmission of the HARQ-ACK may be allocated from the first set of resource indexes.

In an embodiment, the resource index for the transmission of the HARQ-ACK may be allocated to cause concentrated distribution of resource indexes allocated for transmissions of HARQ-ACK on the PUCCH.

In an embodiment, a resource index for the transmission of the HARQ-ACK may be allocated from the first set of resource indexes as a function of:

$${n}_{PUCCH}^{( 1 , {p}_{0} )} = {n}_{ECCE , q} + {Δ}_{ARO} + {N}_{PUCCH , q}^{( m 1 )} ,$$

$${n}_{PUCCH}^{( 1 , {p}_{0} )}$$

may be the allocated resource index, N_{ECCE} may be the number of the lowest enhanced control channel element (ECCE) indexes used to construct a physical downlink control channel (MPDCCH) and Δ_{ARO} is a resource offset of the HARQ-ACK. A value of

$${N}_{PUCCH , q}^{( m 1 )}$$

may be configured to cause the concentrated distribution of the allocated resource indexes.

In an embodiment, the value of

$${N}_{PUCCH , q}^{( m 1 )}$$

may be equal to or less than a threshold value.

In an embodiment, in response to the number of NBs for the PUCCH being greater than the second threshold number, the value of

$${N}_{PUCCH , q}^{( m 1 )}$$

may be set based on a bitmap index of a user equipment, UE, specific search space, USS, associated with the transmission of the HARQ-ACK.

In an embodiment, the second communication may comprise a transmission of a SR on the PUCCH. A different second set of resource indexes available for the transmission of the SR may be determined from resource indexes for the PUCCH. A resource index for the transmission of the SR may be allocated from the second set of resource indexes.

In an embodiment, an available resource index may be searched for in a descending order of resource indexes in the first or second set of resource indexes.

In an embodiment, the second communication may comprise a further transmission of HARQ-ACK on the PUCCH, and a search order of a set of values of Δ_{ARO} may be configured to avoid collision between the transmission of the HARQ-ACK and the further transmission of the HARQ-ACK.

In an embodiment, the search order of the set of values of Δ_{ARO} may be set based on

$${n}_{ECCE} + {N}_{PUCCH , q}^{( m 1 )} .$$

All operations and features related to the network node 130 as described above with reference to FIGS. 1 to 6D are likewise applicable to the method 700 at the terminal device and have similar effects. For the purpose of simplification, the details will be omitted.

### Example Device and Medium

FIG. 8 shows a device 800 in accordance with some embodiments. The device 800 may be an example implementation of the network node 130 or the terminal device 110 or 120 as shown in FIG. 1.

As shown in FIG. 8, the device 800 may comprise a processor 805 and a memory 810. The memory 810 may contain instructions 815 executable by the processor 805, whereby the device 800 may be operative to monitor a change of traffic through a virtual port, wherein the virtual port maps to a plurality of channels; and enable or disable a channel of the plurality of channels based on the monitored change of traffic.

In an embodiment, the device 800 may be operative to implement actions or operations of the network node 130 or the terminal device 110 or 120 according to any of the above-mentioned embodiments described with reference to FIGS. 1 to 7.

The processor 805 may be any kind of processing component, such as one or more microprocessor or microcontrollers, as well as other digital hardware, which may include digital signal processors (DSPs), special-purpose digital logic, and the like. The memory 810 may be any kind of storage component, such as read-only memory (ROM), random-access memory, cache memory, flash memory devices, optical storage devices, etc.

FIG. 9 shows a computer readable storage medium in accordance with some embodiments.

As shown in FIG. 9, the computer readable storage medium 900 comprising instructions 815 which when executed by a processor of a device, cause the device to perform any above-mentioned embodiments described with reference to FIGS. 1 to 7.

The computer readable storage medium 900 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives.

In some embodiments, an apparatus capable of performing the methods 200, 230, 500 or 700 may comprise means for performing the respective operations of the method 200, 230, 500 or 700. The means may be implemented in any suitable form. For example, the means may be implemented in a circuitry or software module. The apparatus may comprise means for monitoring a change of traffic through a virtual port, wherein the virtual port maps to a plurality of channels; and means for enabling or disabling a channel of the plurality of channels based on the monitored change of traffic.

### Example System, UE and Network Node

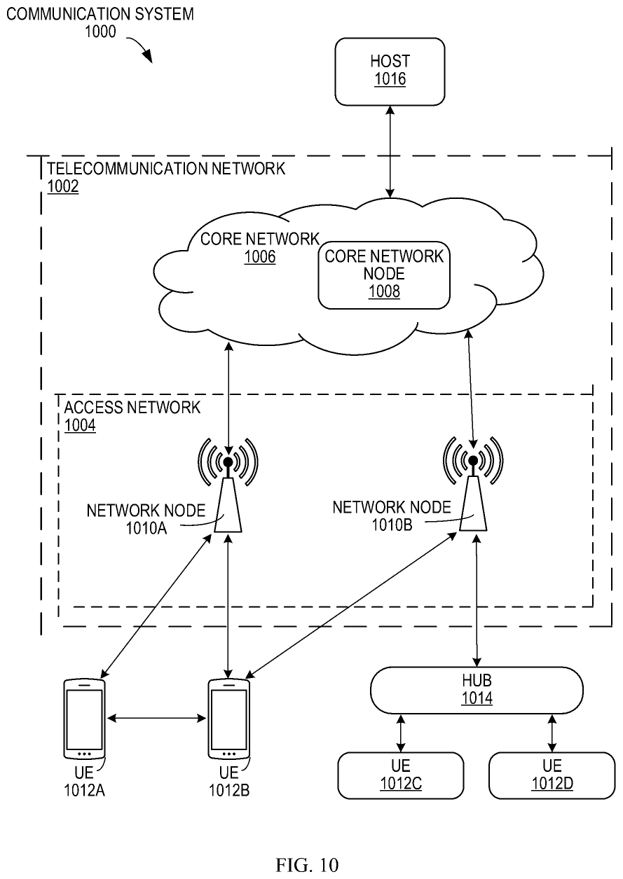

FIG. 10 shows an example of a communication system 1000 in accordance with some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3^{rd} Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

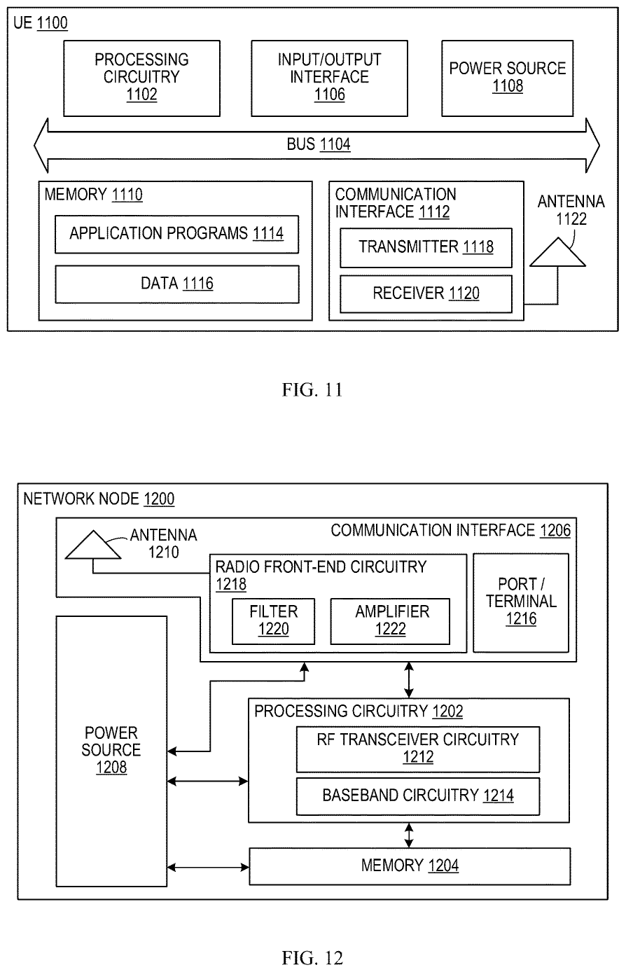

FIG. 11 shows a UE 1100 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1100 includes processing circuitry 1102 that is operatively coupled via a bus 1104 to an input/output interface 1106, a power source 1108, a memory 1110, a communication interface 1112, and/or any other component, or any combination thereof. Certain UEs may utilize all or a subset of the components shown in FIG. 11. The level of integration between the components may vary from one UE to another UE. Further, certain UEs may contain multiple instances of a component, such as multiple processors, memories, transceivers, transmitters, receivers, etc.

The processing circuitry 1102 is configured to process instructions and data and may be configured to implement any sequential state machine operative to execute instructions stored as machine-readable computer programs in the memory 1110. The processing circuitry 1102 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1102 may include multiple central processing units (CPUs).

In the example, the input/output interface 1106 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1100. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1108 is structured as a battery or battery pack. Other types of power sources, such as an external power source (e.g., an electricity outlet), photovoltaic device, or power cell, may be used. The power source 1108 may further include power circuitry for delivering power from the power source 1108 itself, and/or an external power source, to the various parts of the UE 1100 via input circuitry or an interface such as an electrical power cable. Delivering power may be, for example, for charging of the power source 1108. Power circuitry may perform any formatting, converting, or other modification to the power from the power source 1108 to make the power suitable for the respective components of the UE 1100 to which power is supplied.

The memory 1110 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1110 includes one or more application programs 1114, such as an operating system, web browser application, a widget, gadget engine, or other application, and corresponding data 1116. The memory 1110 may store, for use by the UE 1100, any of a variety of various operating systems or combinations of operating systems.

The memory 1110 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1110 may allow the UE 1100 to access instructions, application programs and the like, stored on transitory or non-transitory memory media, to off-load data, or to upload data. An article of manufacture, such as one utilizing a communication system may be tangibly embodied as or in the memory 1110, which may be or comprise a device-readable storage medium.

The processing circuitry 1102 may be configured to communicate with an access network or other network using the communication interface 1112. The communication interface 1112 may comprise one or more communication subsystems and may include or be communicatively coupled to an antenna 1122. The communication interface 1112 may include one or more transceivers used to communicate, such as by communicating with one or more remote transceivers of another device capable of wireless communication (e.g., another UE or a network node in an access network). Each transceiver may include a transmitter 1118 and/or a receiver 1120 appropriate to provide network communications (e.g., optical, electrical, frequency allocations, and so forth). Moreover, the transmitter 1118 and receiver 1120 may be coupled to one or more antennas (e.g., antenna 1122) and may share circuit components, software or firmware, or alternatively be implemented separately.

In the illustrated embodiment, communication functions of the communication interface 1112 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1112, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1100 shown in FIG. 11.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 12 shows a network node 1200 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1200 includes a processing circuitry 1202, a memory 1204, a communication interface 1206, and a power source 1208. The network node 1200 may be composed of multiple physically separate components (e.g., a NodeB component and a RNC component, or a BTS component and a BSC component, etc.), which may each have their own respective components. In certain scenarios in which the network node 1200 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1200 may be configured to support multiple radio access technologies (RATs). In such embodiments, some components may be duplicated (e.g., separate memory 1204 for different RATs) and some components may be reused (e.g., a same antenna 1210 may be shared by different RATs). The network node 1200 may also include multiple sets of the various illustrated components for different wireless technologies integrated into network node 1200, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1200.

The processing circuitry 1202 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1200 components, such as the memory 1204, to provide network node 1200 functionality.

In some embodiments, the processing circuitry 1202 includes a system on a chip (SOC). In some embodiments, the processing circuitry 1202 includes one or more of radio frequency (RF) transceiver circuitry 1212 and baseband processing circuitry 1214. In some embodiments, the radio frequency (RF) transceiver circuitry 1212 and the baseband processing circuitry 1214 may be on separate chips (or sets of chips), boards, or units, such as radio units and digital units. In alternative embodiments, part or all of RF transceiver circuitry 1212 and baseband processing circuitry 1214 may be on the same chip or set of chips, boards, or units.

The memory 1204 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1202. The memory 1204 may store any suitable instructions, data, or information, including a computer program, software, an application including one or more of logic, rules, code, tables, and/or other instructions capable of being executed by the processing circuitry 1202 and utilized by the network node 1200. The memory 1204 may be used to store any calculations made by the processing circuitry 1202 and/or any data received via the communication interface 1206. In some embodiments, the processing circuitry 1202 and memory 1204 is integrated.

The communication interface 1206 is used in wired or wireless communication of signaling and/or data between a network node, access network, and/or UE. As illustrated, the communication interface 1206 comprises port(s)/terminal(s) 1216 to send and receive data, for example to and from a network over a wired connection. The communication interface 1206 also includes radio front-end circuitry 1218 that may be coupled to, or in certain embodiments a part of, the antenna 1210. Radio front-end circuitry 1218 comprises filters 1220 and amplifiers 1222. The radio front-end circuitry 1218 may be connected to an antenna 1210 and processing circuitry 1202. The radio front-end circuitry may be configured to condition signals communicated between antenna 1210 and processing circuitry 1202. The radio front-end circuitry 1218 may receive digital data that is to be sent out to other network nodes or UEs via a wireless connection. The radio front-end circuitry 1218 may convert the digital data into a radio signal having the appropriate channel and bandwidth parameters using a combination of filters 1220 and/or amplifiers 1222. The radio signal may then be transmitted via the antenna 1210. Similarly, when receiving data, the antenna 1210 may collect radio signals which are then converted into digital data by the radio front-end circuitry 1218. The digital data may be passed to the processing circuitry 1202. In other embodiments, the communication interface may comprise different components and/or different combinations of components.

In certain alternative embodiments, the network node 1200 does not include separate radio front-end circuitry 1218, instead, the processing circuitry 1202 includes radio front-end circuitry and is connected to the antenna 1210. Similarly, in some embodiments, all or some of the RF transceiver circuitry 1212 is part of the communication interface 1206. In still other embodiments, the communication interface 1206 includes one or more ports or terminals 1216, the radio front-end circuitry 1218, and the RF transceiver circuitry 1212, as part of a radio unit (not shown), and the communication interface 1206 communicates with the baseband processing circuitry 1214, which is part of a digital unit (not shown).

The antenna 1210 may include one or more antennas, or antenna arrays, configured to send and/or receive wireless signals. The antenna 1210 may be coupled to the radio front-end circuitry 1218 and may be any type of antenna capable of transmitting and receiving data and/or signals wirelessly. In certain embodiments, the antenna 1210 is separate from the network node 1200 and connectable to the network node 1200 through an interface or port.

The antenna 1210, communication interface 1206, and/or the processing circuitry 1202 may be configured to perform any receiving operations and/or certain obtaining operations described herein as being performed by the network node. Any information, data and/or signals may be received from a UE, another network node and/or any other network equipment. Similarly, the antenna 1210, the communication interface 1206, and/or the processing circuitry 1202 may be configured to perform any transmitting operations described herein as being performed by the network node. Any information, data and/or signals may be transmitted to a UE, another network node and/or any other network equipment.

The power source 1208 provides power to the various components of network node 1200 in a form suitable for the respective components (e.g., at a voltage and current level needed for each respective component). The power source 1208 may further comprise, or be coupled to, power management circuitry to supply the components of the network node 1200 with power for performing the functionality described herein. For example, the network node 1200 may be connectable to an external power source (e.g., the power grid, an electricity outlet) via an input circuitry or interface such as an electrical cable, whereby the external power source supplies power to power circuitry of the power source 1208. As a further example, the power source 1208 may comprise a source of power in the form of a battery or battery pack which is connected to, or integrated in, power circuitry. The battery may provide backup power should the external power source fail.

Embodiments of the network node 1200 may include additional components beyond those shown in FIG. 12 for providing certain aspects of the network node's functionality, including any of the functionality described herein and/or any functionality necessary to support the subject matter described herein. For example, the network node 1200 may include user interface equipment to allow input of information into the network node 1200 and to allow output of information from the network node 1200. This may allow a user to perform diagnostic, maintenance, repair, and other administrative functions for the network node 1200.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

1-85. (canceled)

86. A method of a network node, comprising:
performing a first communication with a terminal device using a plurality of narrow bands (NBs) to mitigate collision between the first communication and a different second communication with a terminal device.

87. The method of claim 86, wherein
the method further comprises allocating, in the plurality of NBs, a resource for the first communication to mitigate the collision between the first and second communications.

88. The method of claim 87, wherein
the first communication is performed with a first radio interface technology, RIT, and the second communication is performed with a different second RIT.

89. The method of claim 88, wherein
allocating the resource comprises allocating, in the plurality of NBs, at least one NB for the first communication with the first RIT,
the allocated at least one NB is separate from at least one NB of the plurality of NBs for a coreset associated with the second RIT,
the second communication is performed on the at least one NB of the plurality of NBs for the coreset, and
the first communication comprises:
a transmission of system information, SI,
a transmission of a system information block, SIB, or
a transmission in a common search space, CSS, available for a machine type communication, MTC, physical downlink control channel, MPDCCH.

90. The method of claim 89, wherein
an NB of the plurality of NBs comprises a plurality of resource blocks, and an order for searching resource blocks in the at least one NB allocated for the first communication with the first RIT is reversed from an order for allocating resource blocks of the at least one NBs of the plurality of NBs for the coreset associated with the second RIT.

91. The method of claim 88, wherein
the first communication comprises a transmission of system information, SI, and an index of the NB is allocated for the transmission of SI to reduce loss of resources for the second communication.

92. The method of claim 87, wherein
the first communication comprises a transmission in a common search space, CSS, available for a machine type communication, MTC, physical downlink control channel, MPDCCH, and
allocating the resource comprises allocating, in the plurality of NBs, continuous NBs for the transmission in the CSS,
the continuous NBs are allocated for the transmission in a type-2 common search space, CSS2, and
the second communication comprises:
a transmission of system information block type 1, SIB1;
a transmission of system information, SI;
a transmission in a type-1 common search space, CSS1, for the MPDCCH;
a transmission of a synchronization signal; and/or
a transmission on a physical broadcast channel, PBCH.

93. The method of claim 87, wherein
the first communication comprises a transmission in a user equipment, UE, specific search space, USS, for a machine type communication, MTC, physical downlink control channel, MPDCCH or a transmission on a physical downlink shared channel, PDSCH, associated with the MPDCCH,
allocating the resource comprises allocating, in the plurality of NBs, at least one NB for the transmission in the USS for the MPDCCH or the transmission on the PDSCH,
the allocated at least one NB excludes an NB for a transmission of a synchronization signal and/or an NB for a transmission on a physical broadcast channel, PBCH, and
the second communication comprises the transmission of the synchronization signal and/or the transmission on the PBCH.

94. The method of claim 93, wherein
the first communication is performed with a first radio interface technology, RIT,
the second communication comprises a transmission in a coreset associated with a different second RIT,
at least one NB of the plurality of NBs for the coreset has the lowest priority for allocating the at least one NB for the first communication, and
the coreset comprises coreset #0.

95. The method of claim 93, wherein
the at least one NB allocated for the transmission in the USS for the MPDCCH or the transmission on the PDSCH is reused for:
a transmission of system information block type 1, SIB1;
a transmission of system information, SI; or
a transmission in a type-1 common search space, CSS1, on the MPDCCH;
allocating the at least one NB comprises determining that the transmission in the USS for the MPDCCH or the transmission on the PDSCH is to conflict with the transmission of SIB1 on at least one subframe in the at least one NB to be allocated, and
in response to the number of repetitions for the transmission in the USS for the MPDCCH or the transmission on the PDSCH being equal to or greater than a first threshold number, allocating the at least one NB for the transmission in the USS for the MPDCCH or the transmission on the PDSCH.

96. The method of claim 95, wherein
the method further comprises:
in response to the number of repetitions for the transmission in the USS being less than the first threshold number, determining whether that the USS is valid; and
based on a determination that the USS is valid, increasing the number of repetitions; or
in response to the number of repetitions for the transmission on the PDSCH being less than the first threshold number, increasing the number of repetitions, and
the number of repetitions is increased to a next higher available number.

97. The method of claim 95, wherein
the method further comprises, in response to the number of repetitions for the transmission in the USS for the MPDCCH or on the PDSCH being equal to or greater than the first threshold number, dropping the conflicting at least one subframe to avoid collision between the transmission in the USS for the MPDCCH or on the PDSCH and the transmission of SIB1.

98. The method of claim 95, wherein
allocating the at least one NB comprises, in response to no collision of the transmission in the USS for the MPDCCH or the transmission on the PDSCH with the transmission in the CSS1 on the MPDCCH or the transmission of the SI in the at least one NB to be allocated, allocating the at least one NB for the transmission in the USS for the MPDCCH or the transmission on the PDSCH,
the transmission of the SI is performed on at least one predetermined subframe and/or in a predetermined frame after cell setup, and
the at least one predetermined subframe comprises continuous subframes.

99. The method of claim 88, wherein
the first RIT comprises category M, and the second RIT comprises long term evolution, LTE, or new radio, NR.

100. The method of claim 86, wherein
the first communication is performed on a machine type communication, MTC, physical downlink control channel, MPDCCH, with repetitions.

101. The method of claim 100, wherein
the method further comprises:
determining that a preamble is qualified before a starting of the MPDCCH, wherein the preamble corresponds to the MPDCCH; and
blocking preamble selection of a terminal device in a time interval after the qualification of the preamble and before the starting of the MPDCCH,
the preamble is determined to be qualified on a target subframe earlier than a starting subframe of the MPDCCH, and
three subframes are between the target subframe and the starting subframe.

102. The method of claim 100, wherein
the MPDCCH is associated with a first common search space, CSS, and a different second CSS.

103. The method of claim 102, wherein
the method further comprises:
determining that a first preamble in a first list of preambles associated with the first CSS and a second preamble in a second list of preambles associated with the second CSS are both qualified before a starting of the MPDCCH, wherein the first and second preambles correspond to the MPDCCH; and
blocking a preamble in one of the first and second lists of preambles in a time interval after the qualification of the first and second preambles and before the starting of the MPDCCH, wherein a CSS of the first and second CSSs associated with the other of the first and second lists is scheduled in a previous scheduling occasion.

104. The method of claim 102, wherein
the method further comprises:
determining that a first preamble in a first list of preambles associated with the first CSS is qualified before a starting of the MPDCCH, wherein the first preamble corresponds to the MPDCCH; and
blocking a preamble in the first list of preambles in a time interval after the qualification of the first preamble and before the starting of the MPDCCH.

105. A network node, comprising:
a processor; and
a memory, the memory containing instructions executable by the processor, wherein the network node is operative to perform of:
performing a first communication with a terminal device using a plurality of narrow bands (NBs) to mitigate collision between the first communication and a different second communication with a terminal device.
